(19) United States
(12) Patent Application Publication
(10) Pub. No.: US 2017/0186038 A1
(43) Pub. Date: Jun. 29, 2017

(54) Providing Advertisements based on Contextual Data

(71) Applicant: Quixey, Inc., Mountain View, CA (US)

(72) Inventors: Eric GLOVER, Palo Alto, CA (US); Tomer KAGAN, Sunnyvale, CA (US); Nikhil SRINIVASAN, Lexington, MA (US); Taher SAVLIWALA, Mountain View, CA (US)

(21) Appl. No.: 14/979,846

(22) Filed: Dec. 28, 2015

(51) Int. Cl. G06Q 30/02; G06F 17/30

(52) U.S. Cl. CPC G06Q 30/0261; G06Q 30/0267; G06F 17/30241; G06F 17/30528; G06Q 30/0264; G06Q 30/0269

(57) ABSTRACT

An advertisement (ad) server that receives ad campaigns from advertiser computers. An ad campaign includes conditions that trigger the ad. The ad server stores the ad campaigns in ad records of an ad data store. The ad server receives an ad request from a mobile computing device. The ad request includes contextual data that indicates a context of the mobile computing device. The ad server provides an ad to the mobile computing device, if the ad server determines that the conditions associated with the ad are satisfied based on the contextual data included in the ad request.

### TECHNICAL FIELD

This disclosure relates to providing advertisements to a mobile computing device based on contextual data.

### BACKGROUND

Many mobile computing devices can display advertisements (ads). A mobile computing device can display an ad in a browser. For example, an ad displayed by the browser may include a banner ad. Some mobile computing devices can display ads within other applications that are installed on the mobile computing device. For example, a mobile computing device can display an ad within a gaming application. Many users of mobile computing devices do not interact with the ads because the users do not consider the ads to be relevant. Displaying ads that are not relevant results in a misallocation of valuable real estate on the device screen. Displaying ads that the users do not interact with may also result in lost revenues for software developers.

### SUMMARY

One aspect of the disclosure provides an advertisement (ad) server that provides ads to mobile computing devices. The ad server includes a network communication device, a storage device, and a processing device. The storage device stores an entity data store, and an ad data store. The entity data store stores entity records. Each entity record stores information regarding an entity, and one or more locations associated with the entity. The ad data store stores ad records. Each ad record corresponds with one of the entities stored in the entity data store. Each ad record stores one or more conditions. Each ad record stores information that can be utilized to advertise the corresponding entity when the one or more conditions are satisfied. The processing device executes computer-readable instructions that, when executed by the processing device, cause the processing device to perform one or more operations. The processing device may receive an ad campaign that specifies an entity, and one or more conditions that trigger an ad for the entity. The processing device determines a set of locations associated with the entity based on the information stored in the entity data store. The processing device generates an ad record for the entity specified in the ad campaign. The generated ad record include the one or more conditions that trigger the advertisement for the entity, and the set of locations associated with the entity. The processing device stores the generated ad record in the ad data store.

The ad server receives an advertisement request. The advertisement request may include contextual data that indicates a context of a mobile computing device. The ad server may determine a current location of the mobile computing device based on the contextual data. The ad server selects an ad record from the ad data store upon determining that the current location of the mobile computing device is within a threshold distance of one or more of the locations referenced by the ad record. The ad server generates an advertisement object that includes information from the selected ad records. The ad server transmit the advertisement object to the mobile computing device via the network communication device.

Another aspect of the disclosure provides a computer-implemented method for providing advertisements (ads). The method may include receiving, via a network communication device of an ad server, an ad campaign that specifies an entity, and one or more conditions that trigger an ad for the entity. The method may include determining, at a processing device of the ad server, a set of locations associated with the entity based on the information stored in the entity data store. The method may include generating, by the processing device, an ad record for the entity specified in the ad campaign. The generated ad record comprises the one or more conditions that trigger the advertisement for the entity, and the set of locations associated with the entity. The method may include storing the generated ad record in an ad data store that is stored in a storage device of the ad server.

The method may include receiving, via the network communication device, an advertisement request. The advertisement request may include contextual data that indicates a context of a mobile computing device. The method may include determining, at the processing device, a current location of the mobile computing device based on the contextual data. The method may include selecting, by the processing device, an ad record from the ad data store upon determining that the current location of the mobile computing device is within a threshold distance of one or more of the locations referenced by the ad record. The method may include generating, at the processing device, an advertisement object that includes information from the selected ad records. The method may include transmitting, by the processing device, the advertisement object to the mobile computing device via the network communication device.

Another aspect of the disclosure provides a computer program product encoded on a non-transitory computer readable storage medium comprising instructions that when executed by a processing device, of an ad server, cause the processing device to perform one or more operations. The operations may include receiving, via a network communication device of the ad server, an ad campaign that specifies an entity, and one or more conditions that trigger an ad for the entity. The operations may include determining, at the processing device, a set of locations associated with the entity based on the information stored in the entity data store. The operations may include generating, by the processing device, an ad record for the entity specified in the ad campaign. The generated ad record may include the one or more conditions that trigger the advertisement for the entity, and the set of locations associated with the entity. The operations may include storing the generated ad record in an ad data store that is stored in a storage device of the ad server.

The operations may include receiving, via the network communication device, an advertisement request. The advertisement request may include contextual data that indicates a context of a mobile computing device. The operations may include determining, at the processing device, a current location of the mobile computing device based on the contextual data. The operations may include selecting, by the processing device, an ad record from the ad data store upon determining that the current location of the mobile computing device is within a threshold distance of one or more of the locations referenced by the ad record. The operations may include generating, at the processing device, an advertisement object that includes information from the selected ad records. The operations may include transmitting, by the processing device, the advertisement object to the mobile computing device via the network communication device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic diagram of a system that provides advertisements to a mobile computing device.

FIG. 2A is a diagram of an example graphical user interface (GUI) that an advertiser computer can display to allow an advertiser to generate an ad campaign.

FIG. 2B is a diagram that illustrates an ad campaign for a fast food restaurant.

FIG. 2C is a diagram that illustrates an ad campaign for a movie.

FIG. 3 is a block diagram of an ad server that provides an advertisement, if the contextual data satisfies the conditions associated with the advertisement.

FIG. 4 is a block diagram of an example method for generating an ad record based on ad campaign provided by the advertiser computer.

FIG. 5 is a block diagram of an example method for providing an advertisement to a mobile computing device.

FIGS. 6A-7B are diagrams of example GUIs that the advertiser computer can display to receive information regarding ad campaigns.

Like reference symbols in the various drawings indicate like elements.

### DETAILED DESCRIPTION

The present disclosure provides a system for providing advertisements (ads) to mobile computing devices. The system may include a mobile computing device that captures contextual data, and sends the contextual data to a server (e.g., an ad server). The server can identify advertisements that are triggered based on the contextual data. Each ad may be associated with a set of conditions that trigger the ad. The server can determine that a particular ad is triggered, if the contextual data satisfies the conditions (e.g., all the conditions) associated with the ad. The server may receive the ads, and their conditions from an advertiser computer. The advertiser computer can display a graphical user interface (GUI) that allows an advertiser to provide information regarding an ad campaign. For example, the GUI can accept information about an entity that is to be advertised, and the conditions under which the entity is to be advertised.

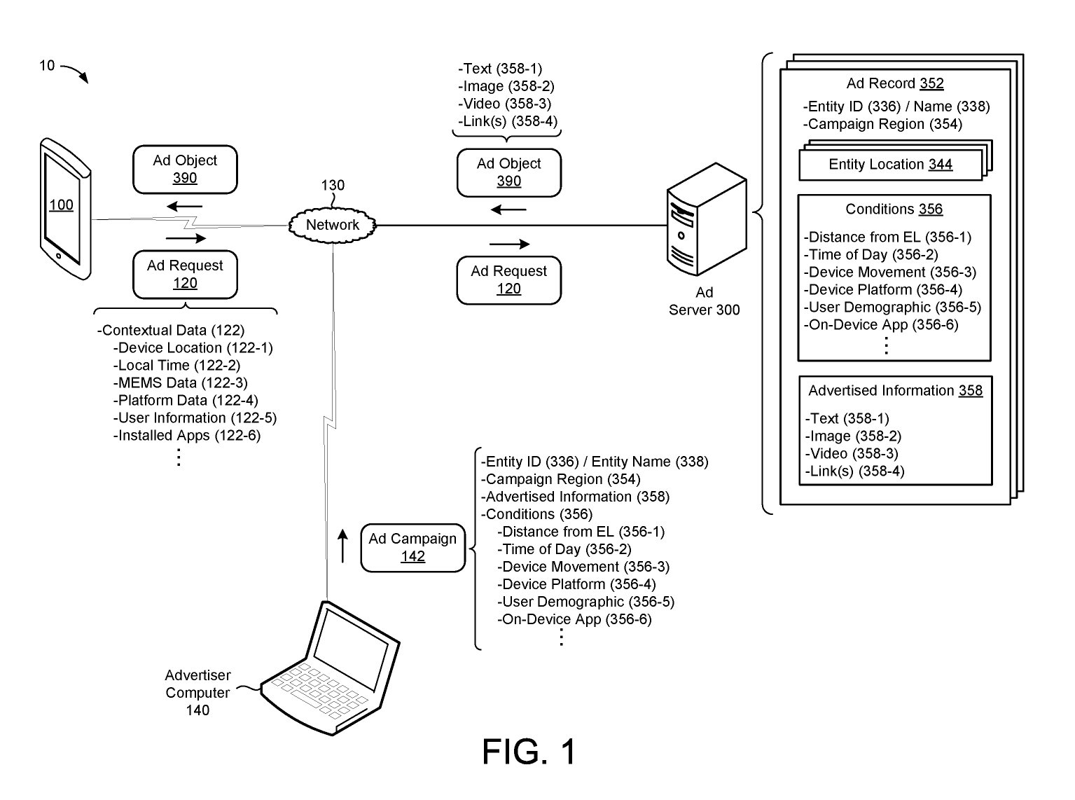

FIG. 1 illustrates an example system 10 for providing ads to a mobile computing device 100. The system 10 includes the mobile computing device 100, an advertiser computer 140, and an ad server 300 (“server 300”, hereinafter). In general, the mobile computing device 100 sends an ad request 120 to the server 300. The ad request includes contextual data 122 that indicates a context of the mobile computing device 100. A context may refer to conditions that the mobile computing device 100 can measure. The server 300 stores various ad records 352 that correspond with advertisements for various entities. The server 300 selects one or more ad record 352 based on the contextual data 122. Upon selecting the ad record 352, the server 300 generates an ad object 390 that includes information from the selected ad record(s) 352. Upon generating the ad object 390, the server 300 sends the ad object 390 to the mobile computing device 100. The server 300 can receive ad campaigns 142 from the advertiser computer 140. The advertised computer 140 may display a GUI that allows a user of the advertiser computer 140 (e.g., an advertiser) to generate the ad campaign 142. The advertiser computer 140 sends the ad campaign 142 to the server 300. The server 300 utilizes the ad campaign 142 to generate an ad record 352.

Referring to the ad campaign 142, the ad campaign 142 may include information that identifies the entity that is to be advertised. For example, the ad campaign 142 may include an entity ID 336 and/or an entity name 338. An entity may refer to any physical or logical object (e.g., person, place, or thing). The ad campaign 142 may specify a campaign region 354 that indicates a geographical boundary for the ad campaign 142. For example, the campaign region 354 may specify a country, a state, or a city where the ad campaign 142 is applicable. The ad campaign 142 may include advertised information 358 that is displayed on the mobile computing device 100 when the ad is triggered. The advertised information 358 may include text 358-1, an image 358-2, a video 358-3, and/or one or more links 358-4.

The ad campaign 142 may include one or more conditions 356 that trigger the ad. The conditions 356 may be referred to as ad triggering conditions. An entity may be associated with one or more entity locations 344. For example, a chain of fast food restaurants (e.g., Chipotle) may have several thousand locations across the world. A first condition 356-1 may specify that the distance between the mobile computing device 100 and any one of the entity locations 344 be less than a threshold distance. For example, a company that owns the chain of fast food restaurants may want to advertise their fast food restaurants to mobile computing devices 100 that are within 1 mi of any one of their locations.

The first condition 356-1 results in geo-fences being created around every entity location 344 associated with the advertised entity (e.g., the entity identified by the entity ID 336 included in the ad campaign 142). The area encompassed by a geo-fence depends on the threshold distance specified in the first condition 356-1. The first condition 356-1 results in geo-fences being created around entity locations 344 that currently do not exist but will exist in the future. In the example of the fast food restaurant chain, if a new location is built in the future, then the first condition 356-1 will result in a geo-fence around the new location. Advantageously, the advertiser will not have to explicitly specify a geo-fence around the newly built restaurant location. The first condition 356-1 also results in no geo-fences around entity locations 344 that currently exist but do not exist in the future. For example, if one of the locations of the fast food restaurant chain closes down, then no geo-fence will be created around the closed location. Advantageously, the advertiser will not have to explicitly remove a geo-fence from around a closed restaurant location.

A second condition 356-2 may specify a time of day during which the ad can be delivered to the mobile computing device 100. In the example of the fast food restaurant, the time of day may be 11:30 am to 1:30 pm. A third condition 356-3 can specify a device movement. For example, the third condition 356-3 can specify that the device movement correspond with a movement that indicates that the user of the mobile computing device 100 is stationary, walking, running, or driving. A fourth condition 356-4 can specify a device platform (e.g., an operating system that is installed on the mobile computing device 100). A fifth condition 356-5 can specify a user demographic (e.g., age, sex, etc.).

A sixth condition 356-6 may specify that the mobile computing device 100 have a particular application. In the example of the chain of fast food restaurants, the sixth condition 356-6 can specify that the mobile computing device 100 have a particular food-ordering application (e.g., so that the user can order food from the fast food restaurant using the food-ordering application). Alternatively, the sixth condition 356-6 can specify that the mobile computing device 100 have an application, in a specific application category, with an application rating that is greater than a rating threshold (e.g., number of stars, number of likes, number of downloads etc.). In the example of the chain of fast food restaurants, the sixth condition 356-6 can specify that the mobile computing device 100 have any application, from the “Travel & Local” category, that has an application rating of at least 4 stars. Other conditions are also contemplated.

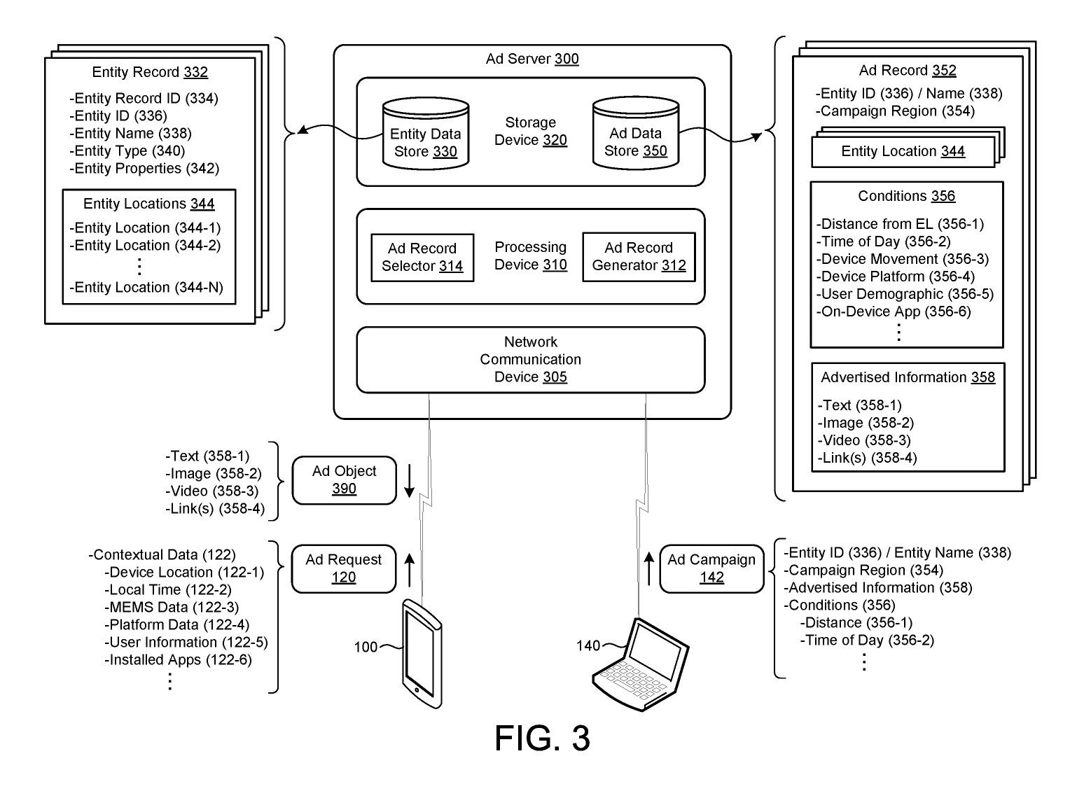

The server 300 receives the ad campaign 142. The server 300 generates an ad record 352 based on the information provided in the ad campaign 142. The ad record 352 may include information that identifies the advertised entity (e.g., the entity ID 336 and/or the entity name 338), the conditions 356 that trigger the ad for the advertised entity, and the advertised information 358. The server 300 can determine the entity locations 344 that are associated with the advertised entity, and store the entity locations 344 in the ad record 352. The server 300 may determine the entity locations 344 by retrieving the entity locations 344 from a data store (e.g., the entity data store 330 shown in FIG. 3) that stores information regarding entities.

In operation, the server 300 receives the ad request 120 from the mobile computing device 100. The ad request 120 includes the contextual data 122. The contextual data 122 may include a device location 122-1, a local time 122-2, MEMS (microelectromechanical systems) data 122-3 that indicates a movement of the mobile computing device 100, platform data 122-4, user information 122-5, and/or information regarding installed application 122-6. The MEMS data 122-3 may be referred to as movement data. The movement data may be from a sensor that determines a location of the mobile computing device 100 (e.g., a Global Positioning System). The server 300 can determine whether the contextual data 122 satisfies all the conditions 356 of any ad record 352. If all the conditions 356 of an ad record 352 are satisfied, then the server 300 retrieves the advertised information 358 from the ad record 352, and sends the advertised information 358 to the mobile computing device 100 within the ad object 390.

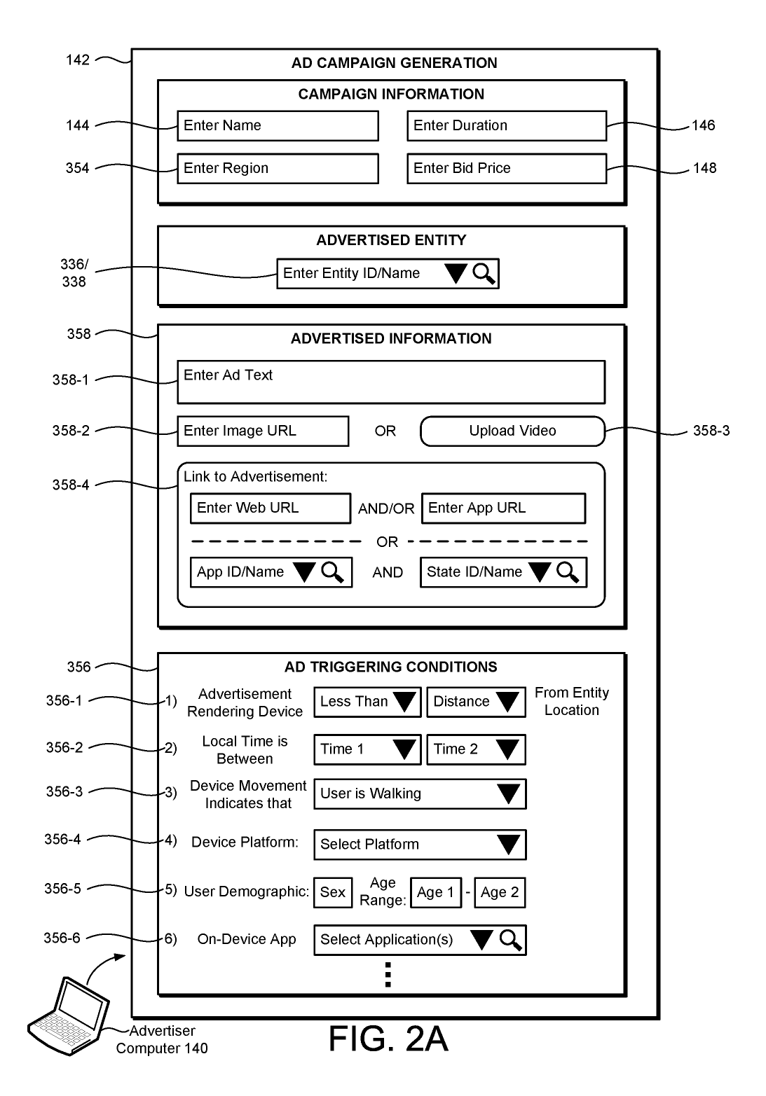

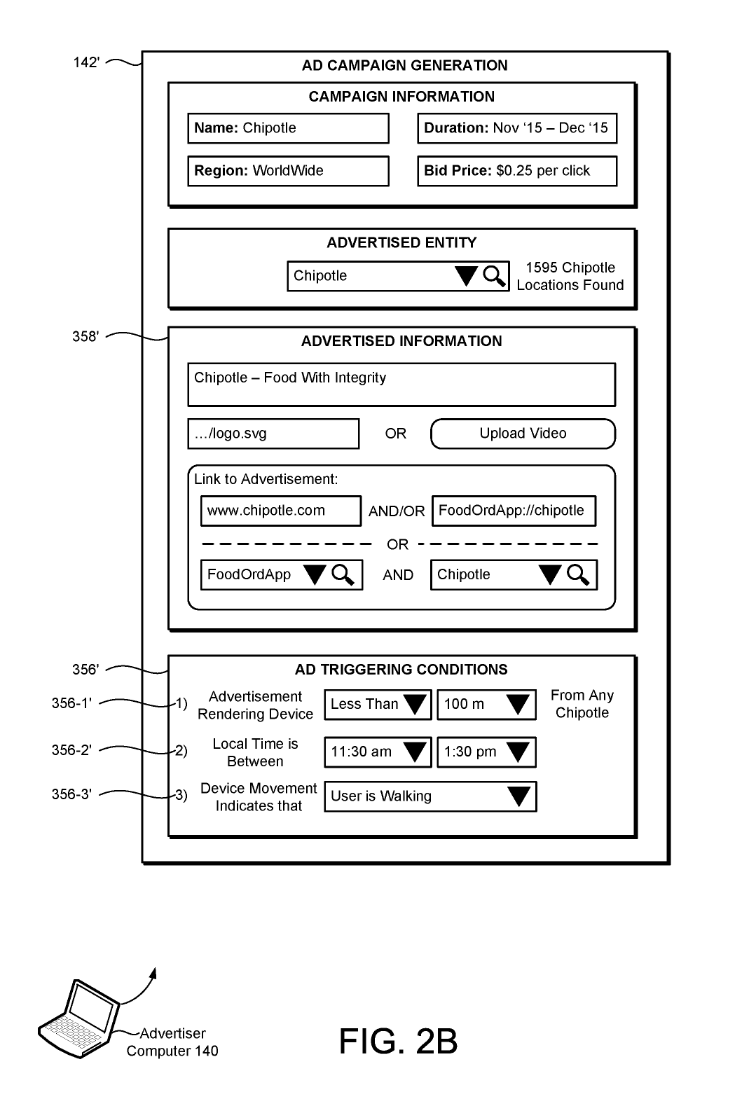

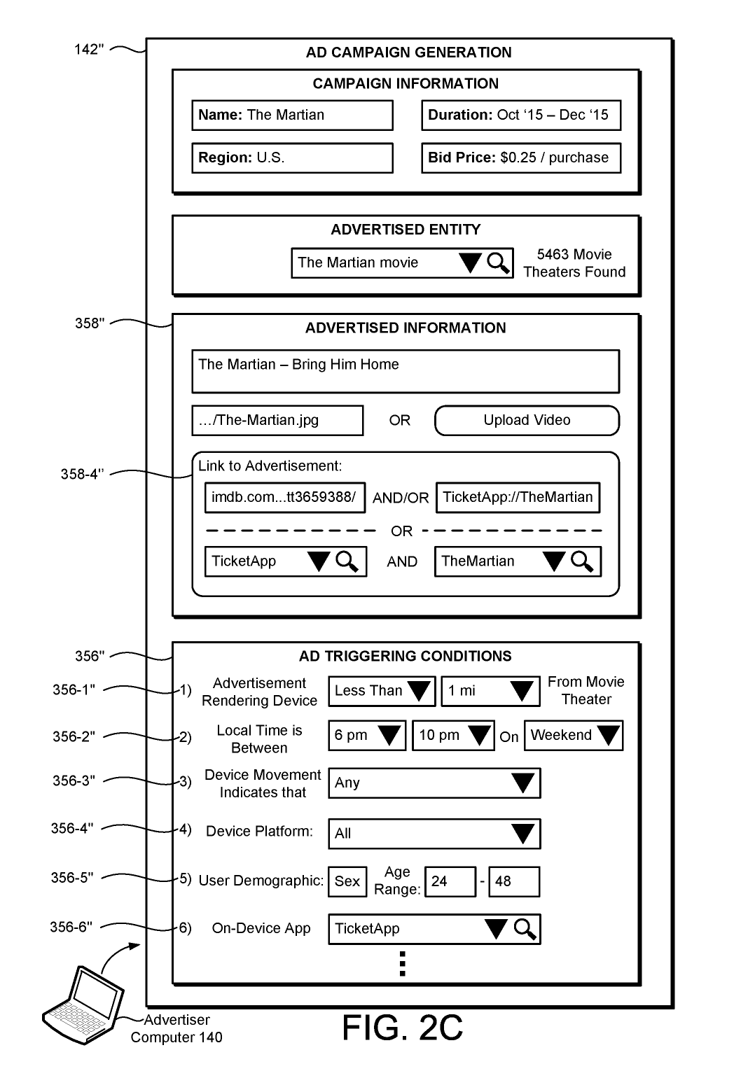

FIG. 2A illustrates an example graphical user interface (GUI) that the advertiser computer 140 can display in order to allow a user of the advertiser computer 140 to generate an ad campaign 142. The GUI can include input elements that accept a campaign name 144, a campaign duration 146, a campaign region 354, and/or a bid price 148. The GUI can also include input elements that accept an entity ID 336, and/or an entity name 338. The GUI can include input elements allow the advertiser to select the entity ID 336 and/or the entity name 338 of a known entity via a drop-down menu, or the user can specify an unknown entity. The GUI can also include input elements that accept advertised information 358 (e.g., text 358-1, image 358-2, video 358-3, and/or links(s) 358-4). The link(s) 358-4 may include a web uniform resource locator (URL), an application uniform resource identifier (URI), or an application ID that identifies an application along with a state ID that identifies a particular state within the application. The GUI can also allow the advertiser to provide the conditions 356.

FIG. 2B illustrates an example ad campaign 142′ for a chain of fast food restaurants (e.g., Chipotle). The server 300 sends the advertised information 358′ to the mobile computing device 100, if the conditions 356′ are satisfied. The first condition 356-1′ is satisfied when the mobile computing device 100 is within 100 m of any of the 1,595 Chipotle locations. The second condition 356-2′ is satisfied when the local time is between 11:30 AM and 1:30 PM. Lastly, the third condition 356-3′ is satisfied when the device movement indicates that the user is walking. If the server 300 determines that the first three conditions 356-1′, 356-2′, and 356-3′ are satisfied, then the server 300 can send the advertised information 358′ to the mobile computing device 100.

FIG. 2C shows an example ad campaign 142″ for a movie called “The Martian”. The server 300 sends the advertised information 358″ to the mobile computing device, if the conditions 358″ are satisfied. The first condition 356-1″ is satisfied when the mobile computing device 100 is within 1 mi of any of the 5,463 movie theater locations that are playing The Martian. The second condition 356-2″ is satisfied when the local time is between 6 pm and 10 pm on a weekend. The third condition 356-3″ specifies that the device movement is not a limiting factor. Similarly, the fourth condition 356-4″ indicates that platform (e.g., operating system) of the mobile computing device 100 is not a limiting factor. The fifth condition 356-5 is satisfied, if the contextual data 122 (e.g., the user information 122-5 shown in FIG. 1) indicates that the user of the mobile computing device 100 is between 24 and 48 years old. Lastly, the sixth condition 356-6 is satisfied, if the mobile computing device 100 includes TicketApp—a particular ticket-purchasing application (e.g., the Fandango® application). If the server 300 determines that the conditions 356″ are satisfied, then the server 300 can send the advertised information 358″ to the mobile computing device 100. The advertised information 358″ may include a link 358-4″. The link 358-4″ may include a mechanism for launching the ticket-purchasing application into a state that allows a user of the mobile computing device 100 to purchase tickets for The Martian movie.

FIG. 3 shows an example block diagram for the server 300. The server 300 includes a network communication device 305, a processing device 310, and a storage device 320. The server 300 may be implemented by a cloud computing platform. The cloud computing platform may include a collection of remote computing services. The cloud computing platform may include computing resources (e.g., the processing device 310). The computing resources may include physical servers that have physical central processing units (pCPUs). The cloud computing resources may include storage resources (e.g., the storage device 320). The storage resources may include database servers that support NoSQL, MySQL, Oracle, SQL Server, or the like. The cloud computing platform may include networking resources (e.g., the network communication device 305). Example cloud computing platforms include Amazon Web Services®, Google Cloud Platform®, Microsoft AZURE™ and Alibaba Aliyun™.

The network communication device 305 communicates with a network (e.g., the network 130 shown in FIG. 1). The network communication device 305 may include a communication interface that performs wired communication (e.g., via Ethernet, Universal Serial Bus (USB) or fiber-optic cables). The network communication device 305 may perform wireless communication (e.g., via Wi-Fi, Bluetooth, Bluetooth Low Energy (BLE), Near Field Communications (NFC), ZigBee, a cellular network, or satellites). The network communication device 305 may include a transceiver. The transceiver may operate in accordance with an Institute of Electrical and Electronics Engineers (IEEE) specification (e.g., IEEE 802.3 or IEEE 802.11). The transceiver may operate in accordance with a 3rd Generation Partnership Project (3GPP) specification (e.g., Code Division Multiple Access (CDMA), Long Term Evolution (LTE), or LTE-Advanced). The transceiver may operate in accordance with a Universal Serial Bus (USB) specification (e.g., via a USB port).

The storage device 320 stores data. The storage device 320 may include one or more computer readable storage mediums. For example, the storage device 320 may include solid state memory devices, hard disk memory devices, optical disk drives, read-only memory, and/or nanotube-based storage devices. The storage device 320 may be connected to the processing device 310 via a bus, and/or a network. Different storage mediums within the storage device 320 may be located at the same physical location (e.g., in the same data center, same rack, or same housing). Different storage mediums of the storage device 320 may be distributed (e.g., in different data centers, different racks, or different housings). The storage device 320 may store an entity data store 330 that stores information regarding entities, and an ad data store 350 that stores information regarding ad campaigns 142.

The entity data store 330 stores entity records 232 that correspond with entities. As described herein, an entity may refer to any logical or physical object (e.g., a person, a place, or a thing). A place may include a point of interest, a business location (e.g., a fast food restaurant, or a movie theater), etc. A physical object may refer to tangible items. An entity may also refer to intangible items such as digital goods (e.g., movies, songs, software applications, etc.). The entity records 332 may store information regarding their corresponding entities. The entity data store 330 may include one or more tables (e.g., look-up tables), indices (e.g., inverted indices), databases, or any other data structure.

An entity record 332 may include an entity record ID 334. The entity record ID 334 may include a string that identifies the entity record 332. The entity record 332 may include an entity ID 336 that identifies the corresponding entity, an entity name 338 an entity type 340, and/or one or more entity properties 342. The entity record 332 may also include one or more entity locations 344. The entity locations 344 refer to locations that may be associated with the entity. For example, if the entity record 332 is for a chain of fast food restaurants, then the entity locations 344 may include the addresses of all fast food restaurants that are in the chain. Similarly, if the entity record 332 is for a movie, then the entity locations 344 may include the addresses of movie theaters that are currently playing the movie. If the entity record 332 is for a tangible product, then the entity locations 344 may include addresses of stores that sell the product.

The ad data store 350 may include ad records 352 that correspond with ad campaigns 142. An ad record 352 may include information that the server 300 received in the ad campaign 142. For example, an ad record 352 may include an entity ID 336, and/or an entity name 338 to indicate the entity with which the ad record 352 corresponds. The ad record 352 may include the campaign region 354 of the ad. The ad record 352 may also reference the entity locations 344 that are associated with the advertised entity. The ad record 352 may include the conditions 356 that trigger the advertisement. Lastly, the ad record 352 may include the advertised information 358.

The processing device 310 may include a collection of one or more computing processors that execute computer readable instructions. The computing processors of the processing device 310 may operate independently or in a distributed manner. The computing processors may be connected via a bus and/or a network. The computing processors may be located in the same physical device (e.g., same housing). The computing processors may be located in different physical devices (e.g., different housings, for example, in a distributed computing system). A computing processor may include physical central processing units (pCPUs). A pCPU may execute computer-readable instructions to implement virtual central processing units (vCPUs). The processing device 310 may execute computer-readable instructions corresponding with an ad record generator 312 that generates the ad records 352, and an ad record selector 314 that selects one or more ad records 352 in response to the ad request 120.

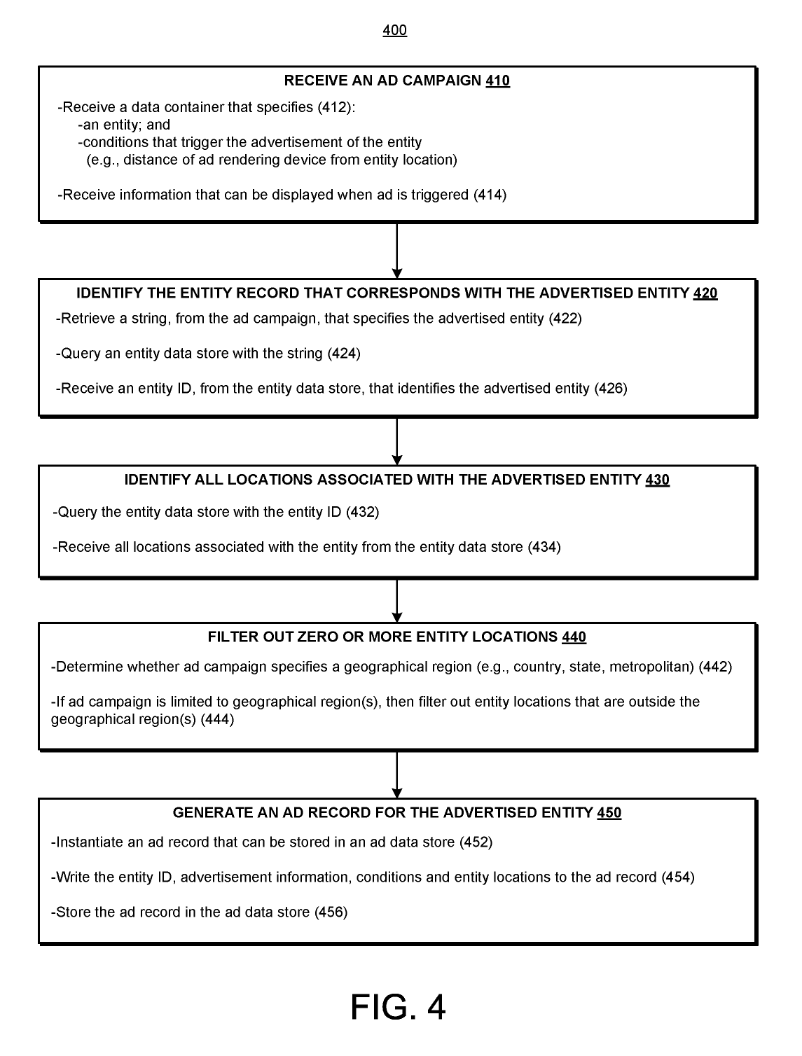

The ad record generator 312 generates the ad records 352 based on the information included in the ad campaigns 142. The ad record generator 312 receives the ad campaign 142. Upon receiving the ad campaign 142, the ad record generator 312 generates an ad record 352 by instantiating the ad record 352, and writing information from the ad campaign 142 into the instantiated ad record 352. The ad record generator 142 can identify the entity locations 344 that are associated with the advertised entity (i.e., the entity indicated in the ad campaign 142). The ad record generator 312 can utilize the entity data store 330 to identify the entity locations 344 that are associated with the advertised entity. For example, the ad record generator 314 can retrieve the entity ID 336 from the ad campaign 142, and query the entity data store 330 for entity locations 344 that correspond with the entity ID 336. In response to such a query, the ad record generator 312 can receive the entity locations 344 that are associated with the advertised entity. FIG. 4, discussed below, illustrates an example method that the ad record generator 312 may execute to generate the ad records 352 based on the ad campaigns 142.

The ad record selector 314 selects one or more ad records 352, based on the ad request 120, in order to generate the ad object 390. The ad record selector 314 receives the ad request 120 from the mobile computing device 100. The ad request 120 includes contextual data 122 that indicates a context of the mobile computing device 100. Upon receiving the ad request 120, the ad record selector 314 selects ad records 352 based on the contextual data 122. Specifically, the ad record selector 314 selects ad records 352 that are triggered by the contextual data 122. Put another way, the ad record selector 314 selects an ad record 352, if the contextual data 122 satisfies the conditions 356 that are specified in the ad record 352.

The ad record selector 314 determines whether the contextual data 122 satisfies the conditions 356 included in an ad record 352. For example, the ad record selector 314 may determine whether the mobile computing device 100 is near any of the entity locations 344 referenced in an ad record 352. The ad record selector 314 can retrieve a device location 122-1 from the contextual data 122. For each entity location 344 referenced by the ad record 352, the ad record selector 314 can compute a distance between the device location 122-1, and the entity location 344. If any one of the computed distances is less than a distance threshold (e.g., the distance threshold specified in the first condition 356-1), then the ad record selector 314 determines that the first condition 356-1 has been satisfied. If there are no additional conditions in the ad record 352, then the ad record selector 314 can select this particular ad record 352. If there are additional conditions 356, then the ad record selector 314 determine whether the other conditions 356 are also satisfied.

In some implementations, the ad record selector 314 can query the ad data store 350 with the device location 122-1. In return, the ad record selector 314 may receive an array of Boolean values where each entry corresponds with an ad record 352 in the ad data store 350. A Boolean value of ‘1’ for a particular ad record 352 may indicate that the mobile computing device 100 is near at least one of the entity locations 344 referenced by the ad record 352. Hence, the ad record selector 314 can select an ad record 352, if the Boolean value for the ad record 352 is ‘1’. A Boolean value of ‘0’ for a particular ad record 352 may indicate that the mobile computing device 100 is not near any of the entity locations 344 referenced by the ad record 352. Hence, the ad record selector 314 may not select an ad record 352, if the Boolean value for the ad record 352 is ‘0’. As described herein, the ad server 300 may determine that the mobile computing device 100 is near a given entity location 344, if a distance between the device location 122-1 and the entity location is less than a threshold distance.

In some implementations, the ad data store 350 may include a mapping mechanism that maps locations to ad record IDs that identify the ad records 352. A location in the mapping mechanism may map to a particular ad record 352, if the location is near any of the entity locations 344 referenced by the ad record 352. The ad record selector 314 can query the mapping mechanism with the device location 122-1, and receive ad record IDs for ad records 352 in return. The ad record IDs that the ad record selector 312 receives may be for ad records 352 that reference entity locations 344 that are near the device location 122-1. The mapping mechanism may include an index (e.g., an inverted index), a look-up table, or any other suitable data structure.

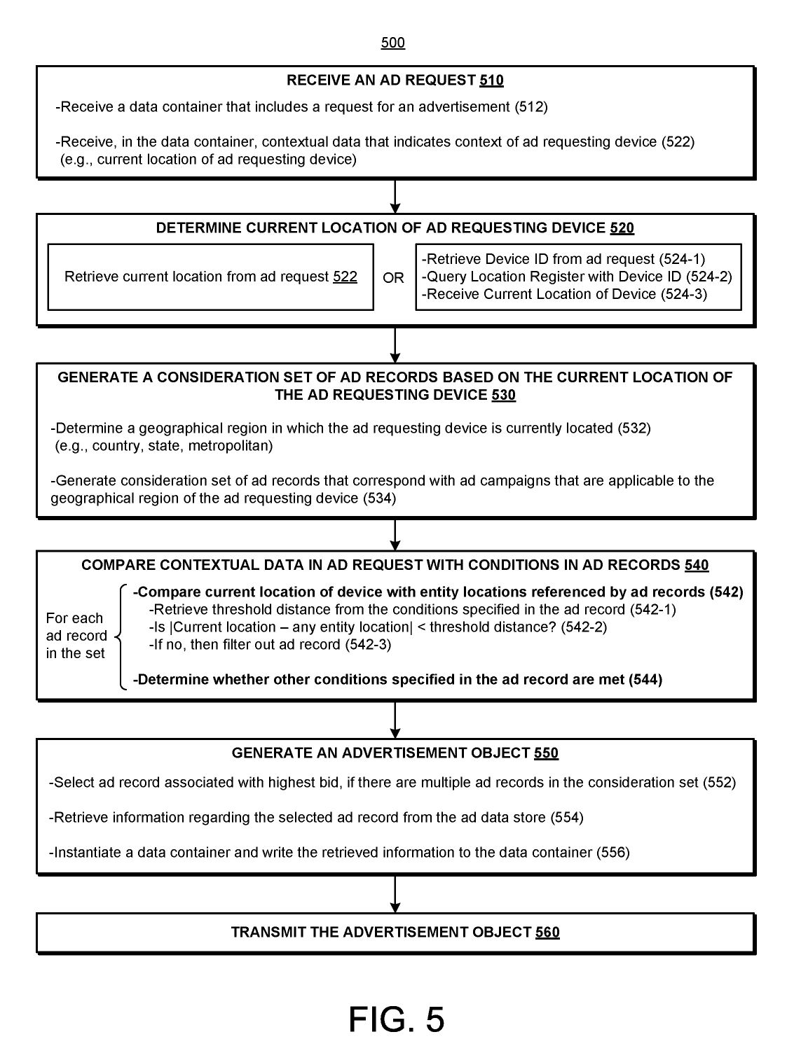

The ad record selector 314 can generate an advertisement object 390 that includes information from the selected ad record(s) 352 and send the advertisement object 390 to the mobile computing device 100. The advertisement object 390 may include the advertised information 358 from the selected ad record(s) 352. For example, the advertisement object 390 may include the text 358-1, the image 358-2, the video 358-3, and/or the link(s) 358-4 from the selected ad record(s) 352. See FIG. 5 for an example method that the ad record selector 314 can execute to select the ad records 352 based on the ad request 120.

In some implementations, the server 300 can determine the entity locations 344 at run-time. In other words, the server 300 can determine the entity locations 344 upon receiving the ad request 120. For example, if the entity locations 344 correspond with store locations of a fast food restaurant, the server 300 can determine that a new store has opened since the ad campaign 142 was created. Hence, the server 300 can include the location of the new store in the entity locations 344. Similarly, the server 300 can determine that one of the store locations has been shut down since the ad campaign 142 was created. Hence, the server 300 can remove the entity location 344 that corresponds with the store that closed down. The server 300 may utilize an online directory to determine the entity locations 344. The online directory may specify addressed of various businesses.

FIG. 4 illustrates an example method 400 for processing an ad campaign that may have been generated at an advertiser computer. The method 400 may be executed by a server (e.g., an ad server, for example, the server 300 shown in FIG. 3). The method 400 may be implemented as a set of computer-readable instructions that are executed by a processing device (e.g., the processing device 310 shown in FIG. 3). In some implementations, the method 400 may be executed by the ad record generator 312 shown in FIG. 3.

Generally, the server receives an ad campaign (at 410). The ad campaign specifies an advertised entity. The server identifies an entity record that corresponds with the advertised entity (at 420). The advertised entity refers to an entity that is to be advertised, as per the ad campaign. The entity may be associated with various entity locations. The server identifies a set of locations (e.g., all the locations) that are associated with the advertised entity (at 430). The locations associated with the advertised entity may be referred to as entity locations. If the ad campaign specifies a geographical region to which the ad campaign is limited, the ad server can filter out entity locations that are outside the geographical region (at 440). At 450, the server generates an ad record for the advertised entity. The ad record can include the set of entity locations that are within the geographical region specified by the ad campaign. The ad record may include additional information that the server can retrieve from the ad campaign (e.g., the conditions for triggering the ad, and the information that the ad displays).

Referring to 410, the server receives the ad campaign. Receiving the ad campaign may include receiving a data container that specifies an entity that is to be advertised (at 412). The entity that is to be advertised may be referred to as the advertised entity. The data container may also include conditions that trigger the advertisement of the entity. The conditions may include the conditions 356 shown in FIG. 3. Receiving the ad campaign may also include receiving information that can be displayed when the ad is triggered (at 414). The information that can be displayed may include the advertisement information 358 shown in FIG. 3.

Referring to 420, the server may identify an entity record that corresponds with the advertised entity. The advertised entity may refer to a known entity. The server may store an entity data store that includes entity records for various entities, and the advertised entity may correspond with one of the stored entity records. The server can retrieve a text string from the ad campaign (at 422). The text string may include one or more phrases. The server can query the entity data store with the text string (at 424). In response to such a query, the server can receive an entity record ID that identifies the corresponding entity record (at 426). Querying the entity data store may include querying an inverted index that maps keywords to entity record IDs. In some implementations, the server may receive an entity ID. For example, the advertiser may have selected the entity ID from a list of entity IDs in a drop-down menu.

At 430, the server can identify locations (e.g., all locations) that are associated with the advertised entity. Locations that are associated with the advertised entity may be referred to as entity locations (e.g., entity locations 344 shown in FIG. 3). In order to identify the entity locations, the server can query the entity data store with the entity record ID (at 432). In response to such a query, the server can receive a set of entity locations (at 434). Querying the entity data store may include querying an inverted index that maps entity record IDs to the entity locations that are stored in respective entity records.

In some scenarios, the ad campaign may specify a campaign region that defines a geographical boundary for the ad campaign. For example, the ad campaign may specify that the ad campaign is only for a particular state, or a particular city. In such scenarios, the server can filter out entity locations that are outside the campaign region specified in the ad campaign (440). At 442, the server determines whether the ad campaign specifies a campaign region (e.g., a geographical boundary) for the ad campaign. The campaign region may include one or more countries, states, cities, towns, etc. If the ad campaign is limited to one or more geographical regions, then the server can filter out entity locations that are outside the specified geographical regions (at 444). Filtering out the entity locations refers to removing the entity locations from the set of entity locations identified at 430. In some implementations, the campaign region may be a function of a current location of the mobile computing device that is requesting an ad. For example, the campaign region can define a perimeter around the mobile computing device (e.g., within 5 miles of the mobile computing device).

Referring to 450, the server generates an ad record for the advertised entity based on the information included in the ad campaign, and the entity locations that the server identified. At 452, the server can instantiate a new ad record that can be stored in an ad data store (e.g., the ad data store 350 shown in FIG. 3). For example, the server may instantiate a new ad record from a predefined ad record template. At 454, the server can write the entity ID, the advertisement information, the conditions, and the entity locations to the ad record. At 456, the server can store the ad record in the ad data store.

FIG. 5 illustrates an example method 500 for providing an advertisement based on contextual data that is received from a mobile computing device. The method 500 may be implemented by a set of computer-readable instructions that can be executed by a server (e.g., the server 300). In some implementations, the method 500 may be executed by the ad record selector 314 shown in FIG. 3. Generally, the ad server receives an ad request (at 510). At 520, the ad server determines a current location of the mobile computing device that sent the ad request. The mobile computing device that sent the ad request may be referred to as the ad requesting device. The ad server may store an ad data store (e.g., the ad data store 350 shown in FIG. 3) that includes ad records that correspond with various ad campaigns. At 530, the ad server generates a consideration set of ad records based on the current location of the ad requesting device. An ad record may include various conditions. At 540, the ad server selects an ad record, if all the conditions included in the ad record are satisfied based on the contextual data. At 550, the ad server generates an advertisement object based on the selected ad record(s). The ad server transmits the ad object to the mobile computing device (at 560).

Referring to 510, the ad server may receive an ad request. The ad server may receive the ad request from a mobile computing device (e.g., an ad requesting device). Receiving the ad request may include receiving a data container that includes a request for an advertisement (at 512). In the data container, the ad server may receive contextual data that indicates a context of the mobile computing device that requested the ad (at 522). FIG. 3 illustrates non-limiting examples of the contextual data.

At 520, the server determines a current location of the ad requesting device. In some implementations the ad request may include the current location. In such implementations, the server can retrieve the current location from the ad request (at 522). Alternatively, the server can determine the location of the ad requesting device based on information included in the ad request. For example, the ad request may include a device ID. The server can retrieve the device ID from the ad request (at 524-1). The server can query a location register (e.g., a Home Location Register (HLR)) with the device ID (at 524-2), and receive the current location of the ad requesting device (at 524-3).

At 530, the server generates a consideration set of ad records based on the current location of the ad requesting device. In some implementations, the ad server determines a geographical region in which the mobile computing device is currently located (at 532). Determining the geographical region of the mobile computing device may include determining a country, a state, or a city in which the mobile computing device is currently located. At 534, the ad server generates a consideration set of ad records that correspond with ad campaigns that are applicable to the geographical region in which the mobile computing device is located. As described herein, many ad campaigns may be limited to a particular geographical region. If an ad campaign is applicable to the geographical region of mobile computing device, the server can include the corresponding ad record for the ad campaign in the consideration set. In some implementations, the server may include an index that maps a geographical region to ad record IDs for ad records that are applicable in that geographical region. The server can query the index with the geographical region of the mobile computing device, and receive the ad record IDs for that geographical region in return.

At 540, the ad server compares the contextual data in the ad request with conditions in the ad records from the consideration set. For each ad record in the consideration set, the ad server can compare the current location of the ad requesting device with the entity locations referenced by the ad records (at 542). Specifically, the ad server can retrieve a threshold distance from the conditions specified in the ad record (at 542-1). For each entity location, the ad server can compute a difference between the current location and the entity location. The ad server can determine whether any of the differences are less than the threshold distance specified in the ad record (at 542-2). If none of the differences are less than the threshold distance, then the ad server can filter out the ad record from the consideration set (at 542-3). If none of the differences are less than the threshold distance, then the ad server can determine that the mobile computing device is not near any of the entity locations. If at least one of the differences is less than the threshold distance, then the ad server can determine that the mobile computing device is near at least one of the entity locations. If the mobile computing device is near an entity location, then the ad server can determine whether other conditions that are specified in the ad record are met (at 544).

Referring to 544, the ad server can determine whether the contextual data satisfies the remaining conditions of the ad record. For example, a condition may specify that the local time at the mobile computing device be within a specific time duration (e.g., time window, for example, 7 pm-10 pm). If the contextual data indicates a time that is within the specified time duration, then this condition is satisfied. Another condition may specify a particular type of movement by the device. For example, the condition may specify that the user be walking. If the contextual data indicates that the user is walking, then this condition is satisfied. Another condition may include a particular demographic of the user. For example, the condition may specify that the user be in a demographic of 30 to 40-year old males. If the contextual data indicates that the user falls within this demographic, then this condition is satisfied.

Some conditions may relate to the applications that are installed at the ad requesting device. For example, a condition may be that the ad requesting device include a specific food-ordering application in order to receive an ad for a fast food restaurant. In this example, if the contextual data indicates that the mobile computing device includes the application specified by the condition, then this condition is satisfied. A condition can specify that the ad requesting device include any application, within an application category, that has a quality rating that exceeds a quality rating threshold. For example, the condition may specify that the ad requesting include any food-ordering application that has rating of at least 4 on a scale of 1 to 5 (e.g., 4 stars). In this example, the server can utilize the contextual data to identify any food-ordering applications that may be installed at the mobile computing device. The server can retrieve the quality ratings of the installed applications from a digital distribution platform that distributes applications. If the rating is above the specified rating threshold, then this condition is satisfied. Other conditions are also contemplated.

At 550, the server generates an advertisement object. If there are multiple ad records remaining in the consideration set, then the server can select the ad record associated with the highest bid (at 552). The server can retrieve information from the selected ad record (at 554). For example, the server can retrieve the advertised information 358 shown in FIG. 3. At 556, the server instantiates a data container, and writes the retrieved information to the data container. For example, the server can write text, an image, a video, and/or a link to the data container. At 560, the server transmits the ad object to the mobile computing device.

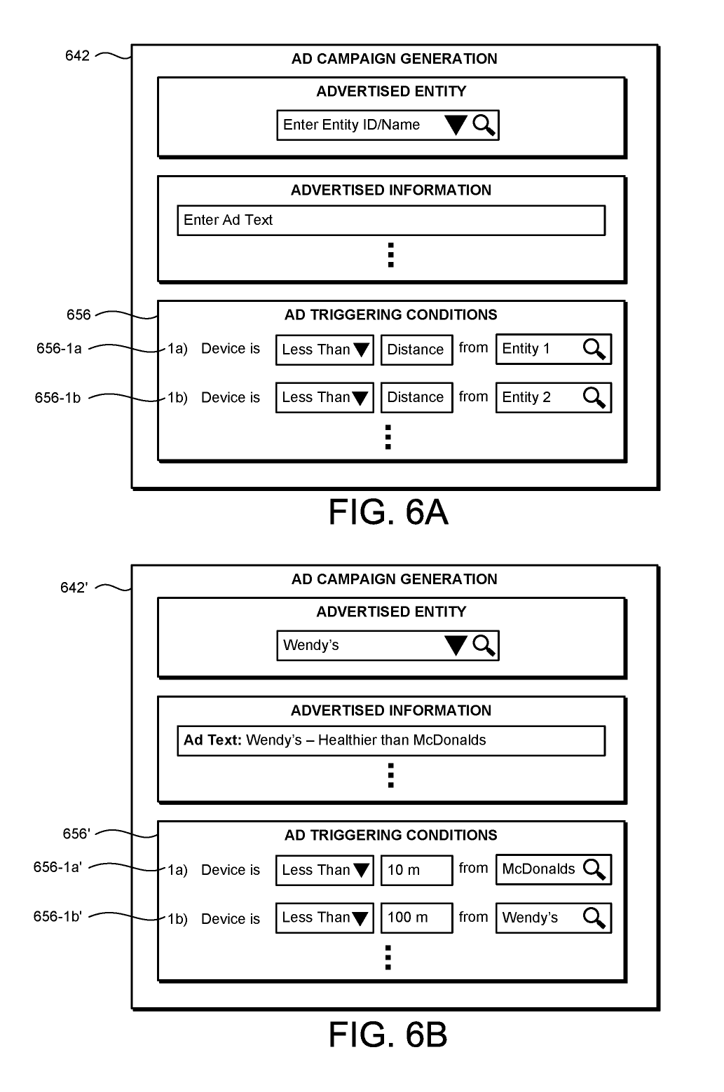

FIG. 6A illustrates an example graphical user interface that the advertiser computer 140 may display to receive an ad campaign 642. Referring to the conditions 656, the advertiser can specify a location of the ad requesting device that depends on the distance of the ad requesting device from two different entities. For example, the first condition 656-1a can specify that the ad requesting device be less than a first distance from a first entity. Moreover, the second condition 656-1b can specify that the ad requesting device be less than a second distance from a second entity. FIG. 6B shows an example ad campaign 642′ for Wendy's®—a chain of fast food restaurants. Referring to the conditions 656′, an ad for Wendy's® can be provided to an ad requesting device, if the ad requesting device is within 10 m of a McDonald's® (as per the first condition 656-1a′), and within 100 m of a Wendy's® (as per the second condition 656-1b′). Wendy's® may create such an ad campaign to lure users who are about to enter a McDonald's®.

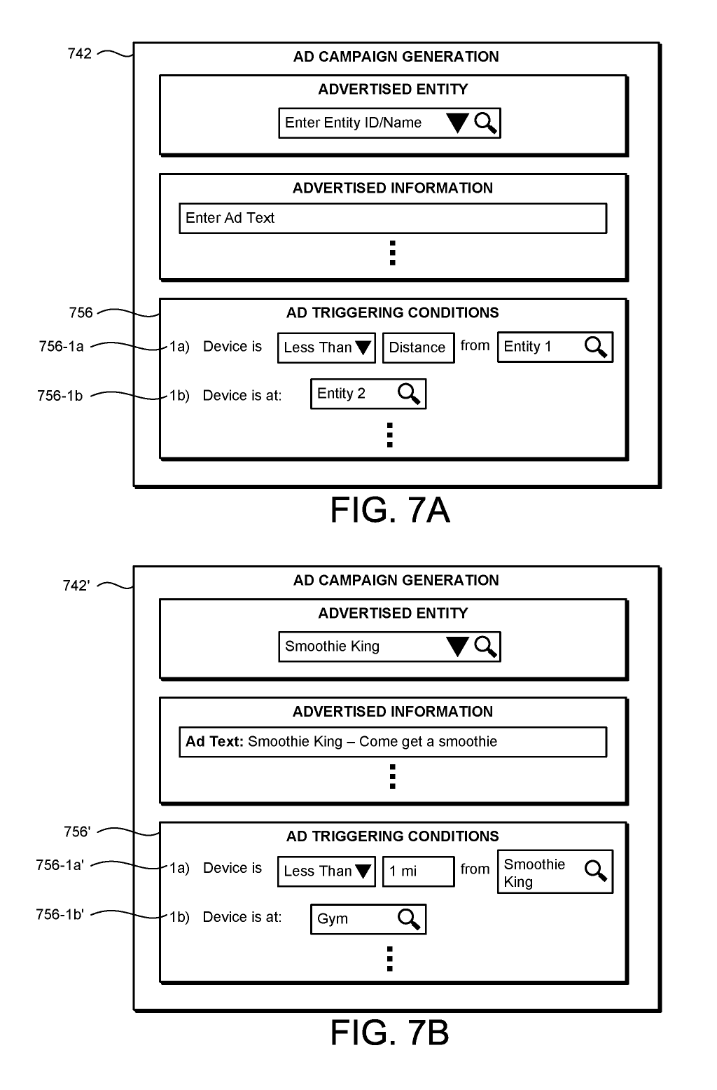

FIG. 7A illustrates an example graphical user interface that the advertiser computer 140 may display to receive an ad campaign 742. Referring to the conditions 756, the advertiser can specify a location of the ad requesting device that depends on the distance of the ad requesting device from a first entity, and whether the ad requesting device is at an entity location associated with a second entity. For example, the first condition 756-1a can specify that the ad requesting device be less than a first distance from a first entity location that is associated with a first entity. Moreover, the second condition 756-1b can specify that the ad requesting device be at a second entity location that is associated with a second entity. FIG. 7B shows an example ad campaign 742′ for Smoothie King—a chain of smoothie food restaurants. Referring to the conditions 756′, an ad for Smoothie can be provided to an ad requesting device, if the ad requesting device is within 1 mi of a Smoothie King (as per the first condition 756-1a′), and at any gym (as per the second condition 756-1b′). Smoothie King may create such an ad campaign for users who may want a protein shake after exercising at the gym.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A server comprising:
a network communication device;
a storage device comprising:
an entity data store that stores entity records, each entity record stores information regarding an entity, and one or more entity locations associated with the entity; and
an advertisement (ad) data store that stores ad records, each ad record corresponds with an ad campaign, each ad record comprises:
an entity identifier (ID) that identifies an entity;
one or more geographical regions associated with the ad campaign;
one or more conditions that trigger an ad for the entity; and
information that can be utilized to advertise the entity when the one or more conditions are satisfied; and
a processing device that executes computer-readable instructions that, when executed by the processing device, cause the processing device to:
receive an ad campaign that specifies an entity, and one or more conditions that trigger an ad for the entity;
determine a set of locations associated with the entity based on the information stored in the entity data store;
generate an ad record for the entity specified in the ad campaign, the generated ad record comprises the one or more conditions that trigger the advertisement for the entity, and the set of locations associated with the entity;
store the generated ad record in the ad data store;
receive an advertisement request, the advertisement request comprising contextual data that indicates a context of a mobile computing device;
determine a current location of the mobile computing device based on the contextual data;
determine a geographical region in which the mobile computing device is current located based on the current location of the mobile computing device;
generate a consideration set of ad records that correspond with ad campaigns that are applicable to the geographical region of the mobile computing device;
select an ad record from the consideration set upon determining that the current location of the mobile computing device is within a threshold distance of one or more of the entity locations associated with the entity that the ad record references;
generate an advertisement object that includes information from the selected ad record; and
transmit the advertisement object to the mobile computing device via the network communication device.

2. The server of claim 1, wherein the ad data store comprises a mapping mechanism that maps a geographical region to ad record IDs that identify ad records that are associated with the geographical region; and wherein generating the consideration set comprises:
querying the mapping mechanism with the geographical region in which the mobile computing device is currently located; and
receiving a set of ad record IDs for ad records that are associated with the geographical region of the mobile computing device.

3. The server of claim 1, wherein selecting the ad record from the consideration set comprises:
for each ad record in the consideration set:
querying the ad data store with the current location of the mobile computing device;
receiving a Boolean value that indicates whether the current location is within a threshold distance of at least one of the entity locations referenced by the ad record; and
selecting the ad record, if the Boolean value is equal to one.

4. The server of claim 1, wherein selecting the ad record comprises:
for each ad record in the consideration set:
retrieving a threshold distance from the ad record;
for each entity location referenced by the ad record, determining a distance between the entity location, and the current location of the mobile computing device; and
selecting the ad record, if at least one of the distances is less than the threshold distance.

5. The server of claim 1, wherein selecting the ad record comprises determining that the contextual data specified in the ad request satisfies the conditions stored in the ad record.

6. The server of claim 5, determining that the contextual data satisfies the conditions comprises determining that a current time is within a specified time duration defined in the ad record.

7. The server of claim 5, wherein one of the conditions defines movement data that indicates that a user of the mobile computing device is walking; and wherein determining that the contextual data satisfies the conditions comprises determining that the contextual data indicates that the user of the mobile computing device is walking.

8. The server of claim 5, wherein determining that the contextual data satisfies the conditions comprises determining that the contextual data indicates that a native application defined in the conditions of the ad records is installed on the mobile computing device.

9. The server of claim 5, wherein determining that the contextual data satisfies the conditions comprises determining that the contextual data indicates that a user of the mobile computing device corresponds to a particular demographic defined in the conditions of ad record.

10. The server of claim 1, wherein determining the set of locations comprises:
querying the entity data store with the entity specified in the ad campaign to identify an entity record that corresponds with the entity; and
retrieving, from the corresponding entity record, a set of locations associated with the entity specified in the ad campaign.

11. A computer-implemented method for providing advertisements (ads), the computer-implemented method comprising:
storing, at a storage device of a server, an entity data store that stores entity records, each entity record stores information regarding an entity, and one or more entity locations associated with the entity;
storing, at the storage device, an advertisement (ad) data store that stores ad records, each ad record corresponds with an ad campaign, each ad record comprises:
an entity identifier (ID) that identifies an entity;
one or more geographical regions associated with the ad campaign;
one or more conditions that trigger an ad for the entity;
information that can be utilized to advertise the entity when the one or more conditions are satisfied;
receiving, via a network communication device of the server, an ad campaign that specifies an entity, and one or more conditions that trigger an ad for the entity;
determining, at a processing device of the server, a set of locations associated with the entity based on the information stored in the entity data store;
generating, at the processing device, an ad record for the entity specified in the ad campaign, the generated ad record comprises the one or more conditions that trigger the advertisement for the entity, and the set of locations associated with the entity;
storing, by the processing device, the generated ad record in the ad data store;
receiving, via the network communication device, an advertisement request, the advertisement request comprising contextual data that indicates a context of a mobile computing device;
determining, by the processing device, a current location of the mobile computing device based on the contextual data;
determining, at the processing device, a geographical region in which the mobile computing device is current located based on the current location of the mobile computing device;
generating, by the processing device, a consideration set of ad records that correspond with ad campaigns that are applicable to the geographical region of the mobile computing device;
selecting, by the processing device, an ad record from the consideration set upon determining that the current location of the mobile computing device is within a threshold distance of one or more of the entity locations associated with the entity that the ad record references;
generating, at the processing device, an advertisement object that includes information from the selected ad record; and
transmitting, by the processing device, the advertisement object to the mobile computing device via the network communication device.

12. The computer-implemented method of claim 11, wherein the ad data store comprises a mapping mechanism that maps a geographical region to ad record IDs that identify ad records that are associated with the geographical region; and wherein generating the consideration set comprises:
querying the mapping mechanism with the geographical region in which the mobile computing device is currently located; and
receiving a set of ad record IDs for ad records that are associated with the geographical region of the mobile computing device.

13. The computer-implemented method of claim 11, wherein selecting the ad record from the consideration set comprises:
for each ad record in the consideration set:
querying the ad data store with the current location of the mobile computing device;
receiving a Boolean value that indicates whether the current location is within a threshold distance of at least one of the entity locations referenced by the ad record; and
selecting the ad record, if the Boolean value is equal to one.

14. The computer-implemented method of claim 11, wherein selecting the ad record comprises:
for each ad record in the consideration set:
retrieving a threshold distance from the ad record;
for each entity location referenced by the ad record, determining a distance between the entity location, and the current location of the mobile computing device; and
selecting the ad record, if at least one of the distances is less than the threshold distance.

15. The computer-implemented method of claim 11, wherein selecting the ad record comprises determining that the contextual data specified in the ad request satisfies the conditions stored in the ad record.

16. A computer program product encoded on a non-transitory computer readable storage medium comprising instructions that when executed by a processing device, of an ad server, cause the processing device to perform operations comprising:
storing, at a storage device of the ad server, an entity data store that stores entity records, each entity record stores information regarding an entity, and one or more entity locations associated with the entity;
storing, at the storage device, an advertisement (ad) data store that stores ad records, each ad record corresponds with an ad campaign, each ad record comprises:
an entity identifier (ID) that identifies an entity;
one or more geographical regions associated with the ad campaign;
one or more conditions that trigger an ad for the entity;
information that can be utilized to advertise the entity when the one or more conditions are satisfied;
receiving, via a network communication device of the ad server, an ad campaign that specifies an entity, and one or more conditions that trigger an ad for the entity;
determining, at the processing device, a set of locations associated with the entity based on the information stored in the entity data store;
generating, at the processing device, an ad record for the entity specified in the ad campaign, the generated ad record comprises the one or more conditions that trigger the advertisement for the entity, and the set of locations associated with the entity;
storing, by the processing device, the generated ad record in the ad data store;
receiving, via the network communication device, an advertisement request, the advertisement request comprising contextual data that indicates a context of a mobile computing device;
determining, by the processing device, a current location of the mobile computing device based on the contextual data;
determining, at the processing device, a geographical region in which the mobile computing device is current located based on the current location of the mobile computing device;
generating, by the processing device, a consideration set of ad records that correspond with ad campaigns that are applicable to the geographical region of the mobile computing device;
selecting, by the processing device, an ad record from the consideration set upon determining that the current location of the mobile computing device is within a threshold distance of one or more of the entity locations associated with the entity that the ad record references;
generating, at the processing device, an advertisement object that includes information from the selected ad record; and
transmitting, by the processing device, the advertisement object to the mobile computing device via the network communication device.

17. The computer program product of claim 16, wherein the ad data store comprises a mapping mechanism that maps a geographical region to ad record IDs that identify ad records that are associated with the geographical region; and wherein generating the consideration set comprises:
querying the mapping mechanism with the geographical region in which the mobile computing device is currently located; and
receiving a set of ad record IDs for ad records that are associated with the geographical region of the mobile computing device.

18. The computer program product of claim 16, wherein selecting the ad record from the consideration set comprises:
for each ad record in the consideration set:
querying the ad data store with the current location of the mobile computing device;
receiving a Boolean value that indicates whether the current location is within a threshold distance of at least one of the entity locations referenced by the ad record; and
selecting the ad record, if the Boolean value is equal to one.

19. The computer program product of claim 16, wherein selecting the ad record comprises:
for each ad record in the consideration set:
retrieving a threshold distance from the ad record;
for each entity location referenced by the ad record, determining a distance between the entity location, and the current location of the mobile computing device; and
selecting the ad record, if at least one of the distances is less than the threshold distance.

20. The computer program product of claim 16, wherein selecting the ad record comprises determining that the contextual data specified in the ad request satisfies the conditions stored in the ad record.
